(19) United States
(12) Patent Application Publication
(10) Pub. No.: US 2018/0299183 A1
(43) Pub. Date: Oct. 18, 2018

(54) Refrigeration System and Heating Assembly

(71) Applicant: Haier US Appliance Solutions, Inc., Wilmington, DE (US)

(72) Inventor: Vineeth Vijayan, Louisville, KY (US)

(21) Appl. No.: 15/486,393

(22) Filed: Apr. 13, 2017

(51) Int. Cl. F25D 21/08; F25D 11/02; H05B 3/44

(52) U.S. Cl. CPC F25D 21/08; H05B 3/44; F25D 11/02

(57) ABSTRACT

In one aspect of the present disclosure, a refrigeration system and heating assembly is generally provided herein. The electrical heater may generally include a conductive sheath, a resistive wire, a thermally conductive electrical insulation, and an electrically-insulating layer. The conductive sheath may define an enclosed volume along a length between a first end portion and a second end portion. The resistive wire may be disposed within the enclosed volume. The thermally conductive electrical insulation may be radially positioned between the resistive wire and the conductive sheath. The electrically-insulating layer may extend along at least a portion of the length. Moreover, the electrically-insulating layer may be radially positioned outward from the conductive sheath.

### FIELD OF THE INVENTION

The present subject matter relates generally to electrical heating assemblies, and more particularly to heating assemblies for refrigerator system.

### BACKGROUND OF THE INVENTION

Refrigeration systems generally include heat exchange systems to cool air therein. For example, refrigerator appliances include a cabinet defining a chilled chamber that is commonly cooled with a sealed circuit having an evaporator. One problem that may be encountered with existing refrigeration systems is inefficient defrosting of the evaporator. Specifically, when the evaporator is active, frost can accumulate on the evaporator and thereby reduce efficiency of the evaporator and overall refrigeration system. One effort to reduce or eliminate frost from the evaporator has been to utilize a heater, such as an electrical heater, to heat the evaporator when the evaporator is not operating.

Utilizing an electrical heater to defrost an evaporator can pose certain challenges. For example, certain refrigeration systems utilize a flammable refrigerant within the sealed system. In such systems, a surface temperature of the heater is generally limited to a temperature well below the auto-ignition temperature of the flammable refrigerant. In addition, a grounding wire is commonly coupled to an outer surface of the heater. The grounding wire may ground the heater and serve to avoid accidental energization of an outer metal sheath. Nonetheless, the evaporator generally requires a certain power output from the heater to suitably defrost. It is possible that a portion of electrical heater may fail. In some instances, a portion of the electrical heater may be damaged, e.g., from mishandling or manufacturing defects. Under certain conditions, the grounding wire may lead to arcing or damage to internal insulation. For example, a heating element may rupture or zipper, resulting in an electrical arc from the heating element. If rupture occurs, the electrical arc may risk igniting a flammable refrigerant.

Accordingly, a heating assembly with certain safety features would be useful. In particular, it would be advantages to provide a heating assembly that does not require a grounding wire and is configured to prevent zippering in an appliance. Moreover, it may also be useful to have a refrigeration system with a heating assembly for defrosting an evaporator of the refrigeration system while operating well below an auto-ignition temperature of a flammable refrigerant within the evaporator.

### BRIEF DESCRIPTION OF THE INVENTION

Aspects and advantages of the invention will be set forth in part in the following description, or may be obvious from the description, or may be learned through practice of the invention.

In one aspect of the present disclosure, a refrigeration system is provided. The refrigeration system may include a sealed system and an electrical heater. The sealed system may be charged with a refrigerant enclosed therein. The sealed system may include an evaporator to transfer heat to the refrigerant. The electrical heater may be positioned adjacent the evaporator. The electrical heater may include a conductive sheath, a resistive wire, a thermally conductive electrical insulation, and an electrically-insulating layer. The conductive sheath may define an enclosed volume along a length between a first end portion and a second end portion. The resistive wire may be disposed within the enclosed volume to generate heat in response to an electrical current. The thermally conductive electrical insulation may be radially positioned between the resistive wire and the conductive sheath. The electrically-insulating layer may extend along at least a portion of the length. Moreover, the electrically-insulating layer may be radially positioned outward from the conductive sheath.

In another aspect of the present disclosure, a heating assembly is provided. The heating assembly may include a conductive sheath, a resistive wire, a thermally conductive electrical insulation, and an electrically-insulating layer. The conductive sheath may define an enclosed volume along a length between a first end portion and a second end portion. The resistive wire may be disposed within the enclosed volume to generate heat in response to an electrical current. The thermally conductive electrical insulation may be radially positioned between the resistive wire and the conductive sheath. The electrically-insulating layer may extend along at least a portion of the length. Moreover, the electrically-insulating layer may be radially positioned outward from the conductive sheath.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a refrigerator appliance according to example embodiments of the present disclosure.

FIG. 2 provides a schematic view of various components of the example embodiments of FIG. 1.

FIG. 3 provides a perspective view of a heating assembly for use in a refrigeration system according to example embodiments of the present disclosure.

FIG. 4 provides a cross-sectional schematic front view of a portion of a heating assembly, according to example embodiments of the present disclosure.

FIG. 5 provides a cross-sectional schematic front view of a portion of a heating assembly, according to other example embodiments of the present disclosure.

FIG. 6 provides a cross-sectional schematic side view of a heating assembly for use in a refrigerator appliance according to example embodiments of the present disclosure.

FIG. 7 provides a cross-sectional schematic side view of a heating assembly for use in a refrigerator appliance according to further example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure provides a heating assembly for use in, as an example, a refrigerator appliance. The heating assembly may assist in defrosting one or more portions of a refrigeration system or sealed system in the refrigerator appliance. The heating assembly may include an electrical heater that has a resistive wire covered by a conductive sheath. An electrically-insulating layer may be placed over the conductive sheath without requiring a grounding wire.

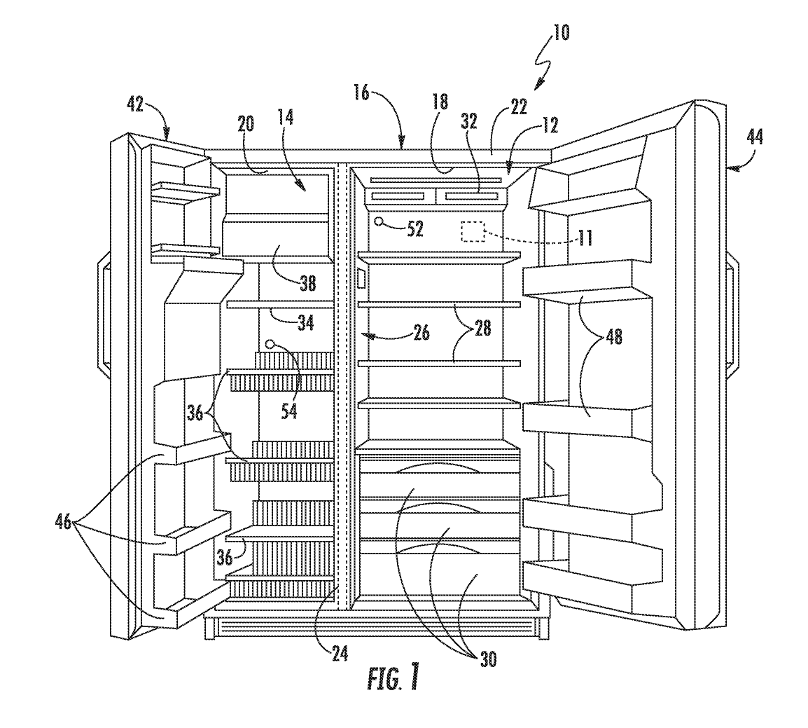

Turning now to the figures, FIG. 1 provides a front view of a representative refrigeration system that includes a refrigerator appliance 10 according to example embodiments of the present disclosure. More specifically, for illustrative purposes, the present disclosure is described with a refrigerator appliance 10 having a construction as shown and described further below. As used herein, a refrigerator appliance includes appliances such as a refrigerator/freezer combination, side-by-side, bottom mount, compact, and any other style or model of refrigerator appliance. Moreover, although shown in the context of a refrigerator appliance, refrigeration system may include other appliances, such as an air-conditioning appliance, stand-alone icemaker appliance, or another appliance including an evaporator unit. Accordingly, other configurations of a refrigeration system may be employed, it being understood that the configuration shown in FIG. 1 is by way of example only.

Refrigerator appliance 10 includes a fresh food storage compartment 12 and a freezer storage compartment 14. Freezer compartment 14 and fresh food compartment 12 are arranged side-by-side within an outer case 16 and defined by inner liners 18 and 20 therein. A space between case 16 and liners 18, 20 and between liners 18, 20 may be filled with foamed-in-place insulation. Outer case 16 normally is formed by folding a sheet of a suitable material, such as pre-painted steel, into an inverted U-shape to form the top and side walls of case 16. A bottom wall of case 16 normally is formed separately and attached to the case side walls and to a bottom frame that provides support for refrigerator appliance 10. Inner liners 18 and 20 are molded from a suitable plastic material to form freezer compartment 14 and fresh food compartment 12, respectively. Alternatively, liners 18, 20 may be formed by bending and welding a sheet of a suitable metal, such as steel.

A breaker strip 22 extends between a case front flange and outer front edges of liners 18, 20. Breaker strip 22 is formed from a suitable resilient material, such as an extruded acrylo-butadiene-styrene based material (commonly referred to as ABS). The insulation in the space between liners 18, 20 is covered by another strip of suitable resilient material, which also commonly is referred to as a mullion 24. In one embodiment, mullion 24 is formed of an extruded ABS material. Breaker strip 22 and mullion 24 form a front face, and extend completely around inner peripheral edges of case 16 and vertically between liners 18, 20. Mullion 24, insulation between compartments, and a spaced wall of liners separating compartments, sometimes are collectively referred to herein as a center mullion wall 26. In addition, refrigerator appliance 10 includes shelves 28 and slide-out storage drawers 30, sometimes referred to as storage pans, which normally are provided in fresh food compartment 12 to support items being stored therein.

Refrigerator appliance 10 can be operated by one or more controllers 11 or other processing devices according to programming and/or user preference via manipulation of a control interface 32 mounted, e.g., in an upper region of fresh food storage compartment 12 and connected with controller 11. Controller 11 may include one or more memory devices and one or more microprocessors, such as a general or special purpose microprocessor operable to execute programming instructions or micro-control code associated with the operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. Controller 11 may include one or more proportional-integral (“PI”) controllers programmed, equipped, or configured to operate the refrigerator appliance according to example aspects of the control methods set forth herein. Accordingly, as used herein, “controller” includes the singular and plural forms.

Controller 11 may be positioned in a variety of locations throughout refrigerator appliance 10. In the illustrated embodiment, controller 11 may be located e.g., behind an interface panel 32 or one of doors 42, 44. Input/output (“I/O”) signals may be routed between the control system and various operational components of refrigerator appliance 10 along wiring harnesses that may be routed through e.g., the back, sides, or mullion 24. Typically, through user interface panel 32, a user may select various operational features and modes and monitor the operation of refrigerator appliance 10. In one embodiment, the user interface panel 32 may represent a general purpose I/O (“GPIO”) device or functional block. In one embodiment, the user interface panel 32 may include input components, such as one or more of a variety of electrical, mechanical or electro-mechanical input devices including rotary dials, push buttons, and touch pads. The user interface panel 32 may include a display component, such as a digital or analog display device designed to provide operational feedback to a user. User interface panel 32 may be in communication with controller 11 via one or more signal lines or shared communication busses.

In some embodiments, one or more temperature sensors are provided to measure the temperature in the fresh food compartment 12 and the temperature in the freezer compartment 14. For example, first temperature sensor 52 may be disposed in the fresh food compartment 12 and may measure the temperature in the fresh food compartment 12. Second temperature sensor 54 may be disposed in the freezer compartment 14 and may measure the temperature in the freezer compartment 14. This temperature information can be provided, e.g., to controller 11 for use in operating refrigerator 10. These temperature measurements may be taken intermittently or continuously during operation of the appliance and/or execution of a control system as further described below.

A shelf 34 and wire baskets 36 are also provided in freezer compartment 14. In addition, an ice maker 38 may be provided in freezer compartment 14. A freezer door 42 and a fresh food door 44 close access openings to freezer and fresh food compartments 14, 12, respectively. Each door 42, 44 is mounted to rotate about its outer vertical edge between an open position, as shown in FIG. 1, and a closed position (not shown) closing the associated storage compartment 14 or 12. In alternative embodiments, one or both doors 42, 44 may be slidable or otherwise movable between open and closed positions. Freezer door 42 includes a plurality of storage shelves 46, and fresh food door 44 includes a plurality of storage shelves 48.

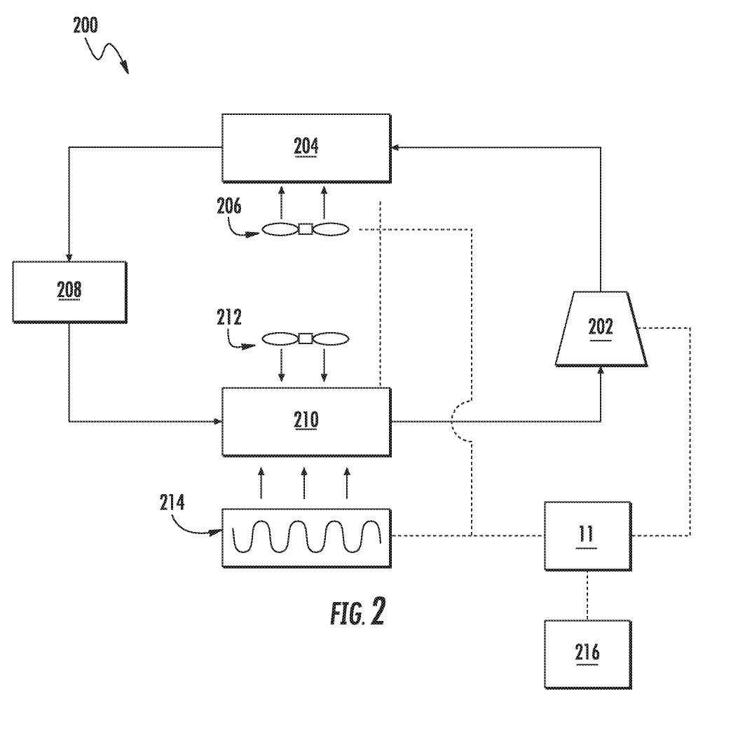

Referring now to FIG. 2, refrigerator appliance 10 may include a sealed system or cooling circuit 200. In general, sealed cooling circuit 200 is charged with a refrigerant that is flowed through various components and facilitates cooling of the fresh food compartment 12 and the freezer compartment 14. Sealed cooling circuit 200 may be charged or filled with any suitable refrigerant. For example, sealed cooling circuit 200 may be charged with a flammable refrigerant, such as R441A, R600a, isobutene, isobutane, etc.

Sealed cooling circuit 200 includes a compressor 202 for compressing the refrigerant, thus raising the temperature and pressure of the refrigerant. Compressor 202 may for example be a variable speed compressor, such that the speed of the compressor 202 can be varied between zero (0) and one hundred (100) percent by controller 11. Sealed cooling circuit 200 may further include a condenser 204, which may be disposed downstream of compressor 202, e.g., in the direction of flow of the refrigerant. Thus, condenser 204 may receive refrigerant from the compressor 202, and may condense the refrigerant by lowering the temperature of the refrigerant flowing therethrough due to, e.g., heat exchange with ambient air. A condenser fan 206 may be used to force air over condenser 204 as illustrated to facilitate heat exchange between the refrigerant and the surrounding air. Condenser fan 206 can be a variable speed fan—meaning the speed of condenser fan 206 may be controlled or set anywhere between and including, e.g., zero (0) and one hundred (100) percent. The speed of condenser fan 206 can be determined by, and communicated to, fan 206 by controller 11.

Sealed cooling circuit 200 further includes an evaporator 210 disposed downstream of the condenser 204. Additionally, an expansion device 208 may be utilized to expand the refrigerant, thus further reduce the pressure of the refrigerant, leaving condenser 204 before being flowed to evaporator 210. Evaporator 210 generally is a heat exchanger that transfers heat from air passing over the evaporator 210 to refrigerant flowing through evaporator 210, thereby cooling the air and causing the refrigerant to vaporize. An evaporator fan 212 may be used to force air over evaporator 210 as illustrated. During operations, cooled air is produced and supplied to refrigerated compartments 12, 14 of refrigerator appliance 10 (FIG. 1). In certain embodiments, evaporator fan 212 can be a variable speed evaporator fan—meaning the speed of fan 212 may be controlled or set anywhere between and including, e.g., zero (0) and one hundred (100) percent. The speed of evaporator fan 212 can be determined by, and communicated to, evaporator fan 212 by controller 11.

Evaporator 210 may be in communication with fresh food compartment 12 and freezer compartment 14 to provide cooled air to compartments 12, 14 (FIG. 1). Alternatively, sealed cooling circuit 200 may include more two or more evaporators, such that at least one evaporator provides cooled air to fresh food compartment 12 and at least one evaporator provides cooled air to freezer compartment 14. In other embodiments, evaporator 210 may be in communication with any suitable component of the refrigerator appliance 10. For example, in some embodiments, evaporator 210 may be in communication with ice maker 38 (FIG. 1), such as with an ice compartment of the ice maker 38. From evaporator 210, refrigerant may flow back to and through compressor 202, which may be downstream of evaporator 210, thus completing a closed refrigeration loop or cycle.

As shown in FIG. 2, a defrost heater 214 may be utilized to defrost evaporator 210, i.e., to melt ice that accumulates on evaporator 210. Heater 214 may be positioned adjacent or in close proximity (e.g., below) evaporator 210 within fresh food compartment 12 and/or freezer compartment 14. Heater 214 may be activated periodically; that is, a period of time t_{ice} elapses between when heater 214 is deactivated and when heater 214 is reactivated to melt a new accumulation of ice on evaporator 210. The period of time t_{ice} may be a preprogrammed period such that time t_{ice} is the same between each period of activation of heater 214, or the period of time may vary. Alternatively, heater 214 may be activated based on some other condition, such as the temperature of evaporator 210 or any other appropriate condition.

Additionally, a defrost termination thermostat 216 may be used to monitor the temperature of evaporator 210 such that defrost heater 214 is deactivated when thermostat 216 measures that the temperature of evaporator 210 is above freezing, i.e., greater than zero degrees Celsius (0° C.). In some embodiments, thermostat 216 may send a signal to controller 11 or other suitable device to deactivate heater 214 when evaporator 210 is above freezing. In other embodiments, defrost termination thermostat 216 may comprise a switch such that heater 214 is switched off when thermostat 216 measures that the temperature of evaporator 210 is above freezing.

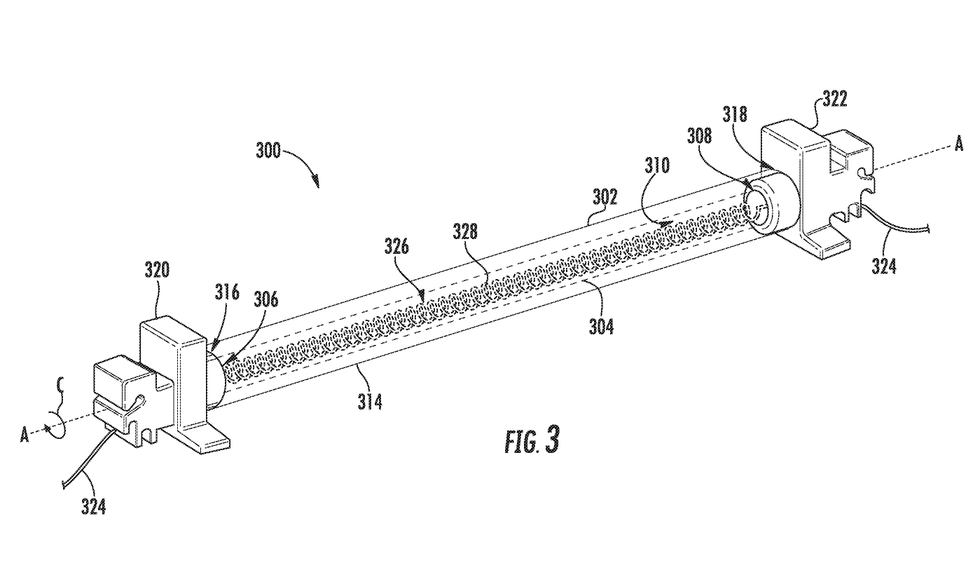

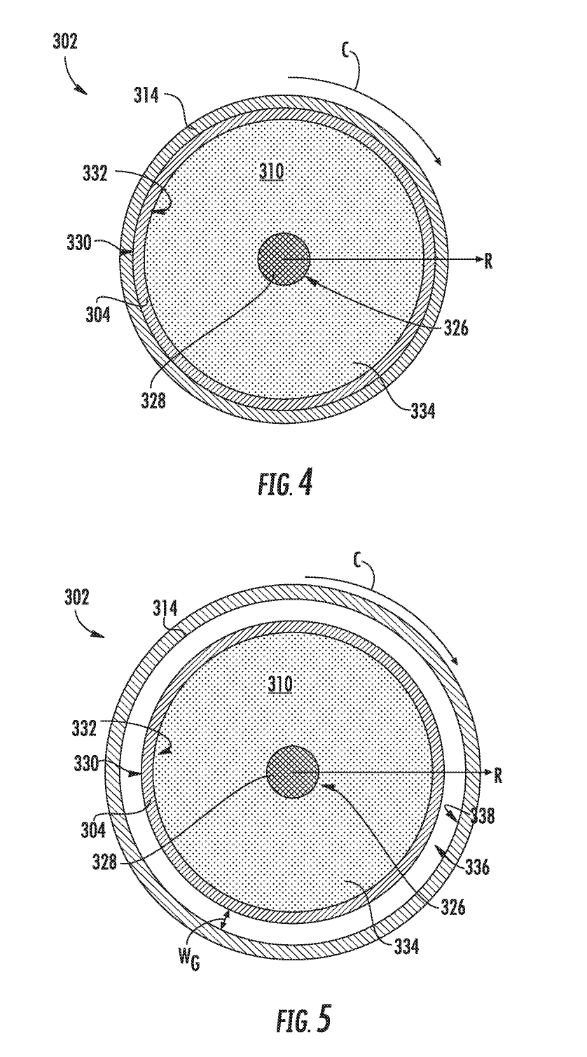

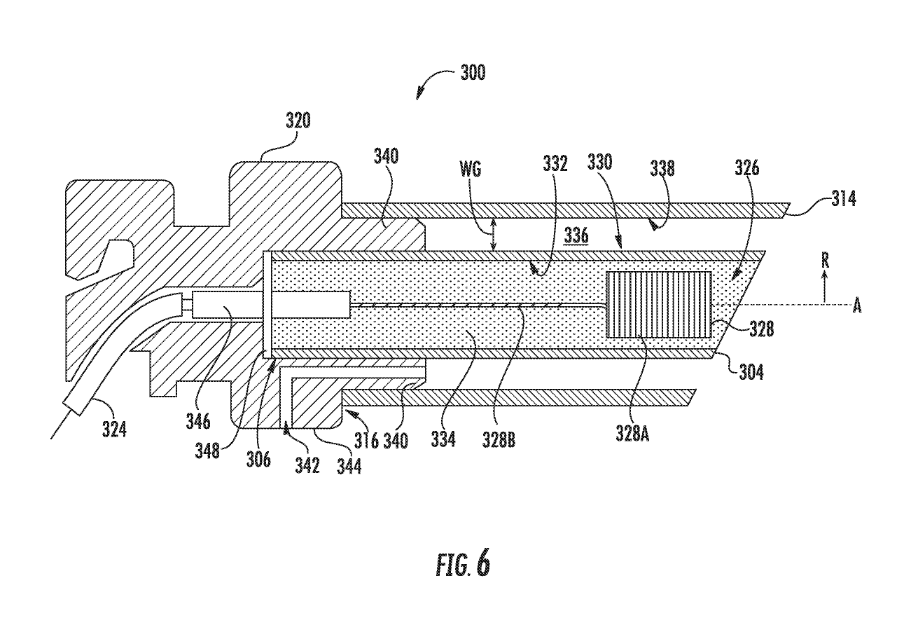

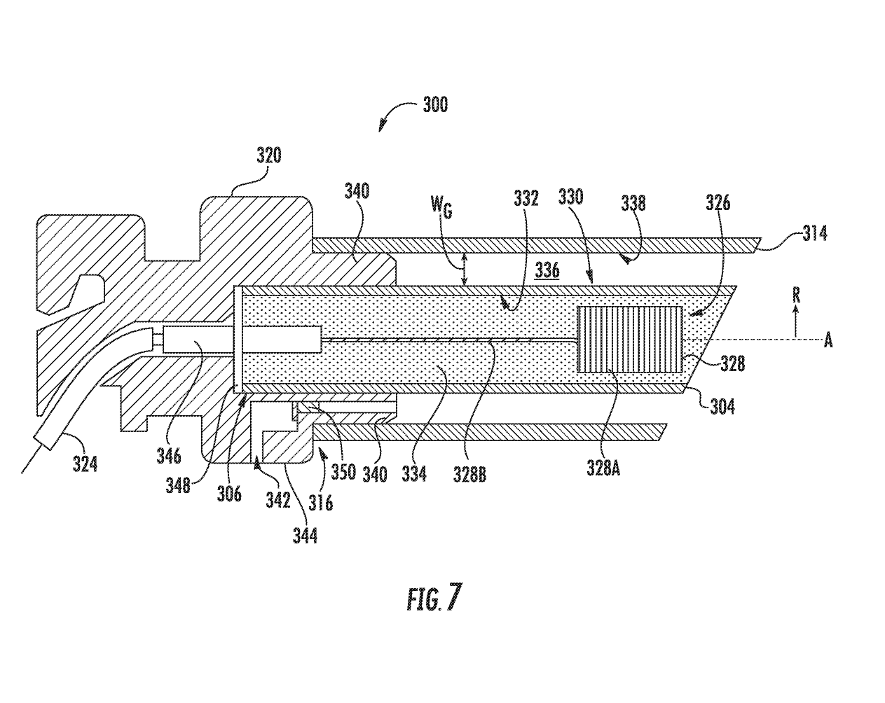

Turning now to FIGS. 3 through 7, multiple embodiments of a heating assembly 300 according to example embodiments of the present disclosure are provided. FIG. 3 provides a schematic view of a heating assembly 300 according to example embodiments of the present disclosure. FIG. 4 provides a cross-sectional schematic front view of a portion of heating assembly 300 according to some embodiments. FIG. 5 provides a cross-sectional schematic front view of a portion of a heating assembly 300 according to other embodiments. FIG. 6 provides a cross-sectional schematic side view of heating assembly 300 according to certain embodiments. FIG. 7 provides a cross-sectional schematic side view of heating assembly 300 according to further embodiments. Although multiple distinct embodiments are illustrated, it is understood that, to the extent each embodiment includes identical features, the same identifying numerals will be used throughout. Moreover, each embodiment of 300 may be considered to be substantially similar, except as otherwise indicated.

Heating assembly 300 generally includes an electrical heater 302 and may be used in or with any suitable refrigerator appliance as a defrost heater. For example, heating assembly 300, including electrical heater 302, may be used as defrost heater 214 in sealed cooling circuit 200 to defrost evaporator 210 (FIG. 2). Thus, heating assembly 300 is discussed below in the context of refrigerator appliance 10 (FIG. 1). Moreover, as discussed in greater detail below, heating assembly 300 includes features for defrosting evaporator 210 while operating such that a surface temperature of heating assembly 300 (e.g., the temperature at an exterior surface 330 of electrically-insulating layer 314) is well below a maximum temperature, which may be an auto-ignition temperature of a flammable refrigerant within evaporator 210. As used herein, the term “well below” means no less than seventy-five degrees Celsius (75° C.) when used in the context of temperatures. Thus, in example embodiments, the surface temperature of heating assembly 300 may be no less than one-hundred degrees Celsius (100° C.) below the auto-ignition temperature of the flammable refrigerant within evaporator 210 during operation of heating assembly 300.

As shown in FIG. 3, heating assembly 300 includes an electrical heater 302 having a conductive sheath 304 that extends along a length between a first end 306 and a second end 308. Specifically, electrical heater 302, including conductive sheath 304 may extend along a central axis A between first end 306 and second end 308. An electrically-insulating layer 314 extends along at least a portion of conductive sheath 304, e.g., about the conductive sheath 304 and central axis A. Although shown as a generally straight member, it is understood that heater 302 may be formed into any suitable shape. For example, heater 302 may generally be U-shaped, circular, arcuate, have multiple coils, etc.

Conductive sheath 304 is formed as a generally solid or non-permeable metal structure that does not permit the passage of liquids, such as water. Conductive sheath 304 may be constructed of or with a suitable thermally conductive metal material. For example, conductive sheath 304 may be constructed of steel, aluminum (including alloys of steel or aluminum). In some embodiments, conductive sheath 304 defines an enclosed volume 310. As shown, enclosed volume 310 may be defined along the length from first end 306 to second end 308. When assembled, enclosed volume 310, including each of first end 306 and second end 308, is sealed to prevent the entry of water or moisture within conductive sheath 304.

As shown, electrically-insulating layer 314 may form a continuous surface that extends along (e.g., parallel to) conductive sheath 304 and/or the central axis A. Electrically-insulating layer 314 is formed as non-conductive and generally solid or non-permeable that does not permit the passage of liquids, such as water. When assembled, electrically-insulating layer 314 may extend from a first end 316 to a second end 318 along the central axis A. Electrically-insulating layer 314 may be continuous along a circumferential direction C, e.g., such that a voltage may not be conducted therethrough. Advantageously, heater 302, including conductive sheath 304, may be electrically insulated at electrically-insulating layer 314, thereby eliminating the need for a grounding connection to conductive sheath 304.

In some embodiments, one or more end caps 320, 322 are disposed at the ends 306, 308 of conductive sheath 304 and/or electrically-insulating layer 314. Each end cap 320 and 322 may be formed from any suitable insulating material to limit or restrict conducted heat and/or electricity from passing from conductive sheath 304 (e.g., silicone rubber) through end cap 320 or 322. In some embodiments, a first end cap 320 is disposed at the first end 306 of conductive sheath 304 and/or the first end 316 of electrically-insulating layer 314. In additional embodiments, a second end cap 322 is disposed at the second end 308 of conductive sheath 304 and/or the second end 318 of electrically-insulating layer 314.

Generally, a resistive heating element 326 is disposed within the heater 302. Specifically, resistive heating element 326 is disposed within the enclosed volume 310 of conductive sheath 304 to generate heat in response to an electrical current. When assembled, resistive heating element 326 may be electrically coupled to a voltage source (not pictured) and/or controller 11 (FIG. 2) through a lead wire 324 extending from end cap(s) 320, 322. In some embodiments, resistive heating element 326 includes a resistive wire 328 formed from a suitable high-resistance material, such as nichrome (i.e., a nickel-chromium alloy), ferrochrome (i.e., an iron-chromium alloy), etc.

Turning now to FIGS. 4 and 5, conductive sheath 304 has an oppositely-disposed pair of surfaces 330, 332 extending along circumferential direction C about central axis A. Specifically, conductive sheath 304 has an exterior surface 330 and interior surface 332. As shown, enclosed volume 310 is generally defined by interior surface 332 within conductive sheath 304. In turn, exterior surface 330 is directed (i.e., faces) radially outward, away from enclosed volume 310, while interior surface 332 is directed radially inward, towards enclosed volume 310. As noted above, when assembled, enclosed volume 310 may be defined along the length from first end 306 to second end 308 (FIG. 3).

In some embodiments, conductive sheath 304 is packed with a thermally conductive electrical insulation 334, such as magnesium dioxide or vitrified magnesite. Specifically, thermally conductive electrical insulation 334 may be radially positioned between resistive heating element 326 and conductive sheath 304. In turn, thermally conductive electrical insulation 334 may separate resistive heating element 326 and conductive sheath 304 along a radial direction R defined from resistive heating element 326. During operation of heater 302, thermally conductive electrical insulation 334 may prevent electrical conduction between resistive heating element 326 and conductive sheath 304, while permitting heat conduction therethrough.

As shown in FIG. 4, in some embodiments, electrically-insulating layer includes, or is formed as, a coating. For instance, electrically-insulating layer 314 may be a coating applied directly on the exterior surface 330 of conductive sheath 304 between first end 316 (FIG. 3) and second end 318 (FIG. 3). As a coating, electrically-insulating layer 314 may be formed from a non-conductive, non-permeable material joined directly to conductive sheath 304. Some such embodiments of electrically-insulating layer 314 may include or be formed from one or more suitable material, such as ceramic, glass, glass ceramic, silicone, or combinations thereof.

As shown in FIGS. 5 through 7, in other embodiments, electrically-insulating layer 314 includes, or is formed as, an insulating sheath that is spaced apart from the conductive sheath 304. Specifically, the sheath of electrically-insulating layer 314 may be spaced apart in the radial direction R (i.e., radially outward from central axis A and/or conductive sheath 304). In turn, a radial gap 336 is defined between electrically-insulating layer 314 and conductive sheath 304. Specifically, radial gap 336 is defined between a radially innermost surface 338 of electrically-insulating layer 314 and the exterior surface 330 of conductive sheath 304. Thus, a width W_{G} (e.g., radial width) of radial gap 336 may be defined between the radially innermost surface 338 of electrically-insulating layer 314 and the exterior surface 330 of conductive sheath 304. In optional embodiments, the width W_{G} is less than the flame quenching distance of a refrigerant, e.g., within sealed cooling circuit 200 (FIG. 2). In such embodiments, flames from an ignited refrigerant may thus be prevented from propagating within radial gap 336.

In some embodiments, resistive wire 328 may be formed to include a coil portion 328A. Coil portion 328A may be coiled, e.g., about the central axis A, along at least a portion of the length of heater 302 between the first end 306 and the second end 308. Optionally, a linear portion 328B of the wire 328 may extend from the coil portion 328A towards either the first end 306 or the second end 308. Moreover, some embodiments may include two discrete linear portions 328B extending from opposite ends of the coil portion 328A towards each of the first end 306 and the second end 308 of conductive sheath 304. It is noted that linear portion 328B may be formed as a folded or twisted wire structure that extends, as an example, along or coaxial with the central axis A. During use, the linear portion 328B may thus operate at a lower temperature than the coil portion 328A.

Turning now specifically to FIGS. 6 and 7, one or more of the end caps (e.g., first end cap 320, as shown in FIGS. 6 and 7) may support a respective end of electrically-insulating layer 314 (e.g., 316, as shown in FIGS. 6 and 7). For instance, a tube collar 340 may be formed on end cap 330. An axial segment of conductive sheath 304 may be held inside, or radially inward from, tube collar 340. Additionally or alternatively, an axial segment of electrically-insulating layer 314 may extend over, or radially outward from, tube collar 340. When assembled, such embodiments of tube collar 340 may thus determine or maintain width W_{G} (e.g., radial width) of radial gap 336. Optionally, tube collar 340 may seal a portion of radial gap 336. In some embodiments, an air passage 342 extends through tube collar 340 to permit air or gas to pass between radial gap 336 and an outer portion 344 of end cap 330 (e.g., at the ambient environment). For instance, air passage 342 may define a width or diameter smaller than a flame quenching distance of a refrigerant, e.g., to prevent a flame from propagating from the ambient environment to the radial gap 336.

In example embodiments, lead wire 324 extends through one or more end caps (e.g., as shown at first end cap 330) and electrically couples resistive wire 328 to a voltage source (not pictured) and/or controller 11 (FIG. 2). Optionally, a coupling pipe 346 extends between resistive wire 328 and lead wire 324. For instance, coupling pipe 346 may extend through a portion of end cap 330 into enclosed volume 310. A positioning plate 348 may support coupling pipe 346, e.g., at each end of conductive sheath 304. Additionally or alternatively, positioning plate 348 may hermetically seal openings of conductive sheath 304, thereby preventing a refrigerant or flame from passing from the ambient environment to the enclosed volume 310.

As shown in FIG. 7, additional or alternative embodiments may include a check valve 350 in communication with air passage 342, e.g., within or along air passage 342. When assembled, check valve 350 may selectively permit a unidirectional airflow from air passage 342 to the outer portion 344 of end cap 330. In other words, air may be permitted from radial gap 336 without passing thereto. In alternative embodiments, a hermetic seal may be formed between radial gap 336 and the ambient environment (e.g., at the end cap 330) to vacuum seal radial gap 336.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigeration system comprising:
a sealed system charged with a refrigerant enclosed therein, the sealed system comprising an evaporator to transfer heat to the refrigerant; and
an electrical heater positioned adjacent the evaporator, the electrical heater comprising a conductive sheath defining an enclosed volume along a length between a first end portion and a second end portion, a resistive wire disposed within the enclosed volume to generate heat in response to an electrical current, a thermally conductive electrical insulation radially positioned between the resistive wire and the conductive sheath, and an electrically-insulating layer extending along at least a portion of the length, the electrically-insulating layer being radially positioned outward from the conductive sheath.

2. The refrigeration system of claim 1, wherein the electrically-insulating layer comprises a coating applied directly on the conductive sheath.

3. The refrigeration system assembly of claim 1, wherein the electrically-insulating layer comprises an insulating sheath spaced apart from the conductive sheath, wherein a radial gap is defined between the conductive sheath and the insulating sheath.

4. The refrigeration system of claim 3, further comprising
an end cap disposed on the first end between the conductive sheath and the insulating sheath, wherein the end cap defines an air passage extending in fluid communication between the radial gap and an outer portion of the end cap.

5. The refrigeration system of claim 4, wherein the end cap comprises a check valve along the air passage to selectively permit unidirectional airflow from the air passage to the outer portion of the end cap.

6. The refrigeration system of claim 4, wherein the radial gap comprises a radial width less than a flame quenching distance of the refrigerant.

7. The refrigeration system of claim 3, wherein the radial gap is vacuum sealed within the insulating sheath.

8. The refrigeration system of claim 1, wherein the electrically-insulating layer comprises ceramic, glass, glass ceramic, or silicone.

9. The refrigeration system of claim 1, wherein the conductive sheath is formed from a metal material.

10. The refrigeration system of claim 1, wherein the refrigerant is a flammable refrigerant.

11. The refrigeration system of claim 10, wherein a maximum surface temperature of the heater is no greater than three hundred and sixty degrees Celsius during operation of the heater.

12. A heating assembly for a consumer appliance, the heating assembly comprising:
a conductive sheath defining an enclosed volume along a length between a first end portion and a second end portion;
a resistive wire disposed within the enclosed volume to generate heat in response to an electrical current;
a thermally conductive electrical insulation radially positioned between the resistive wire and the conductive sheath; and
an electrically-insulating layer extending along at least a portion of the length, the electrically-insulating layer being radially positioned outward from the conductive sheath.

13. The heating assembly of claim 12, wherein the electrically-insulating layer comprises a coating applied directly on the conductive sheath.

14. The heating assembly of claim 12, wherein the electrically-insulating layer comprises an insulating sheath spaced apart from the conductive sheath, wherein a radial gap is defined between the conductive sheath and the insulating sheath.

15. The heating assembly of claim 14, further comprising
an end cap disposed on the first end between the conductive sheath and the insulating sheath, wherein the end cap defines an air passage extending in fluid communication between the radial gap and an outer portion of the end cap.

16. The heating assembly of claim 15, wherein the end cap comprises a check valve along the air passage to selectively permit unidirectional airflow from the air passage to the outer portion of the end cap.

17. The heating assembly of claim 15, wherein the radial gap comprises a radial width less than a flame quenching distance of the refrigerant.

18. The heating assembly of claim 14, wherein the radial gap is vacuum sealed within the insulating sheath.

19. The heating assembly of claim 12, wherein the electrically-insulating layer comprises ceramic, glass, glass ceramic, or silicone.

20. The heating assembly of claim 12, wherein the conductive sheath is formed from a metal material.
